(19) United States
(12) Patent Application Publication
(10) Pub. No.: US 2017/0106804 A1
(43) Pub. Date: Apr. 20, 2017

(54) ARTICLE ATTACHMENT ASSEMBLY SUITABLE FOR VEHICLE

(71) Applicant: FORD GLOBAL TECHNOLOGIES, LLC, Dearborn, MI (US)

(72) Inventors: Shen Jinyun, Nanjing (CN); Jin Xuezhi, Nanjing (CN); Fu Shibao, Nanjing (CN); Xu Wei, Nanjing (CN)

(21) Appl. No.: 15/285,095

(22) Filed: Oct. 4, 2016

(30) Foreign Application Priority Data
Oct. 20, 2015 (CN) 201510685702.2

(51) Int. Cl. B60R 11/02

(52) U.S. Cl. CPC B60R 11/02; B60R 11/0241; B60R 11/0252; B60R 11/0258; B60R 2011/0005

(57) ABSTRACT

An article attachment assembly includes a connector, and an insert to be connected to and rotate about the connector. The insert includes first and second walls connected to each other with an angle positioned there-between. The first wall defines thereupon a first attachment receptor, and the second wall defines thereupon a second attachment receptor different from the first attachment receptor.

### TECHNICAL FIELD

The present invention in one or more embodiments relates to an article attachment assembly suitable for a vehicle.

### BACKGROUND

Automotive interiors often feature various article support holders connected to vehicle interior panels, such as cargo net holders, brackets and hooks, to at least temporarily secure the articles to the vehicle interior.

By way of example, U.S. Pat. No. 8,820,597 B2 discloses a vehicle garment hook and guard mounting assembly, which includes a housing mounted to the vehicle interior trim, a cover slidably coupled to the housing and including an aperture to receive the guard, and a garment hook pivotally mounted to the housing.

### SUMMARY

In one or more embodiments, an article attachment assembly includes a connector, and an insert to be connected to and rotate about the connector. The insert includes first and second walls connected to each other with an angle positioned there-between. The first wall defines thereupon a first attachment receptor. The second wall defines thereupon a second attachment receptor different from the first attachment receptor.

One of the first attachment receptor and the second attachment receptor may be a cargo net holder.

One of the first attachment receptor and the second attachment receptor may be an electronic device holder.

The article attachment assembly may further include a third wall connected to the first and second walls.

The connector may include a pair of connector ends to respectively connect two opposing sides of the insert to a housing.

The connector may further include a shaft to connect the pair of connector ends.

At least one of the connector ends of the connector may include a first protrusion and a second protrusion spaced apart from each other.

At least one of the first and second protrusions may include a polymeric material.

At least one of the pair of connector ends may include an outer shell with a shell material and an inner core with a core material different from the shell material.

The insert may be of an integral one-piece structure.

In another one or more embodiments, an article attachment assembly of a vehicle includes: a housing to be connected to an interior trim of the vehicle; a connector; and an insert to be rotatably connected to housing via the connector. The insert includes a first wall and a second wall connected to each other with a first angle positioned there-between. The first wall defines thereupon a first attachment receptor, and the second wall defines thereupon a second attachment receptor different from the first attachment receptor. The insert further includes a third wall connected to the first wall and the second wall with a second angle and a third angle positioned respectively relative thereto.

The connector may include a pair of connector ends to respectively connect two opposing sides of the insert to the housing. Further, the connector may include a shaft to connect the pair of connector ends. At least one of the connector ends of the connector includes a first protrusion and a second protrusion spaced apart to engage a first recess and a second recess defined on the housing to stabilize positioning of the first wall, the second wall, and the third wall.

At least one of the pair of connector ends includes an outer shell with a shell material and an inner core with a core material different from the shell material.

In another one or more embodiments, an article attachment assembly of a vehicle includes: a housing to be connected to an interior trim of the vehicle and an insert. The insert includes two opposing side walls rotatably connected to the housing via a connector. A first wall and a second wall are positioned between the two opposing side walls. The first wall is formed with a cargo net holder, and the cargo net holder defines thereupon a keyhole slot.

One or more advantageous features as described herein will be readily apparent from the following detailed description of one or more embodiments when taken in connection with the accompanying drawings.

### BRIEF DESCRIPTION OF THE DRAWINGS

For a more complete understanding of one or more embodiments of the present invention, reference is now made to the one or more embodiments illustrated in greater detail in the accompanying drawings and described below wherein:

FIG. 1 illustratively depicts an article attachment assembly as positioned relative to a vehicle interior according to one embodiment of the present invention;

FIG. 2 illustratively depicts a front view of the article attachment assembly referenced in FIG. 1 with an insert thereof being at a covered position;

FIG. 3A illustratively depicts a cross-sectional view of the article attachment assembly referenced in FIG. 2;

FIG. 3B illustratively depicts a cross-sectional view of the article attachment assembly referenced in FIG. 2 with the insert being at a first attachment position;

FIG. 3C illustratively depicts a cross-sectional view of the article attachment assembly referenced in FIG. 2 with the insert being at a second attachment position;

FIG. 4 illustratively depicts a view of an attachment receptor of the article attachment assembly referenced in FIG. 2;

FIG. 5 illustratively depicts a view of a connector of the article attachment assembly referenced in FIG. 2; and

FIG. 6A through FIG. 6C each illustratively depict an enlarged view of a cargo net holder of the article attachment assembly referenced in FIG. 4.

### DETAILED DESCRIPTION OF ONE OR MORE EMBODIMENTS

As referenced in the FIG.s, the same reference numerals may be used to refer to the same parameters and components or their similar modifications and alternatives. These specific parameters and components are included as examples and are not meant to be limiting. The drawings referenced herein are schematic and associated views thereof are not necessarily drawn to scale.

The present invention in one or more embodiments is believed to be advantageous in at least reflecting the understanding that due to certain packaging requirements in modern vehicles, it is desirable to provide a vehicle attachment assembly suitable for various articles to be connected and also to use the vehicle interior space more efficiently.

As detailed herein elsewhere, the present embodiments are believed to be advantageous in providing a vehicle attachment assembly where two or more attachment receptors may be provided for connecting two or more different articles and efficient use of the vehicle interior space may be realized. In particular, an insert is provided to be rotatable about a connector and to include first and second walls respectively defining first and second attachment receptors, such that attachment may be realized at the same location for different purpose, such as to readily attach articles of different types.

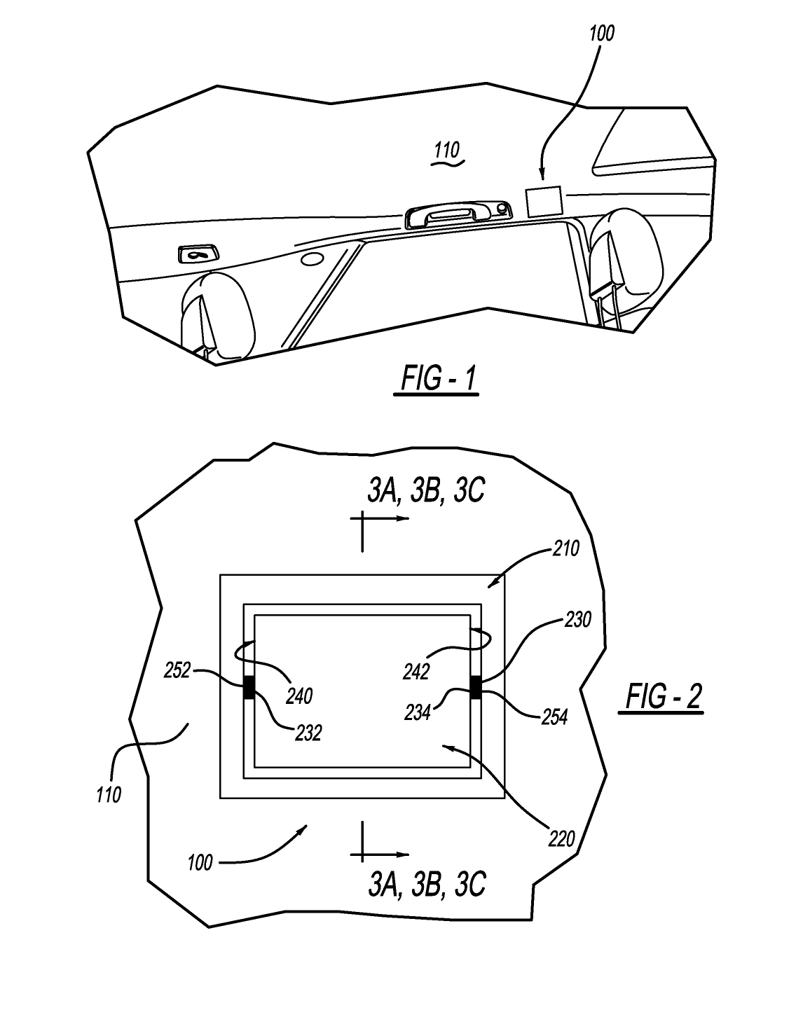

FIG. 1A through FIG. 3C illustratively depict various views of a vehicle attachment assembly 100 according to one or more embodiments. The vehicle attachment assembly 100 includes a connector 230 and an insert 220 to be connected to and rotate about the connector 230. The insert 220 includes a first wall 312 and a second wall 314 connected to each other with an angle positioned there-between. The first wall 312 defines thereupon a first attachment receptor 320, and the second wall 314 defines thereupon a second attachment receptor 330 different from the first attachment receptor 320.

For illustration purposes, the attachment assembly 100 is shown as positioned at a vehicle roof 110 in the specification and drawings. However, the article attachment assembly 100 may be employed at other locations of the vehicle such as, but not limited to, vehicle side panels, vehicle interior door trims and vehicle back door trims. In addition, the article attachment assembly 100 may be employed on a wall or surface of any suitable structural interior other than that of a vehicle, with non-limiting examples thereof including a water vessel interior, an airplane interior, a residential or commercial building interior. For brevity, the article attachment assembly 100 is described herein in relation to a vehicle interior.

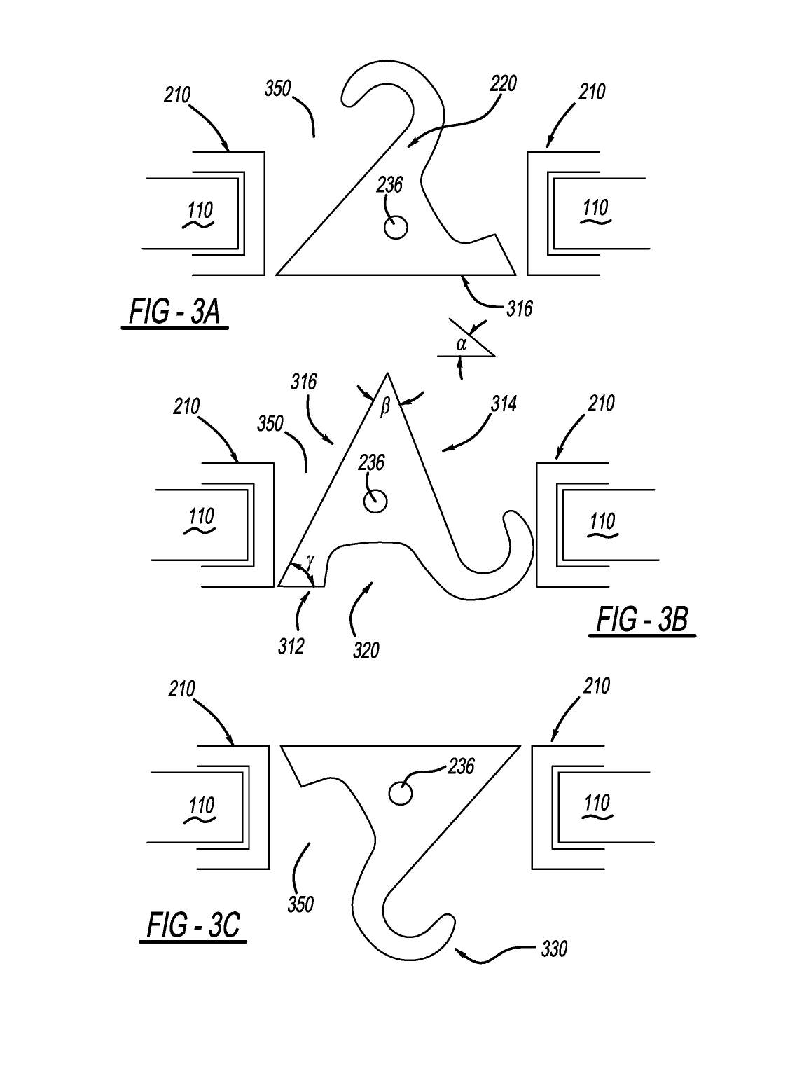

Referring to FIG. 2, FIG. 3A and FIG. 3B, and in one or more embodiments, the vehicle attachment assembly 100 may include a housing 210. The housing 210 may be connected to an interior trim 110 of the vehicle, and the insert 220 may be connected to the housing 210 via the connector 230. It is to be appreciated that in other embodiments, the vehicle attachment assembly 100 may not include the housing 210, and the insert 220 may be directly connected to the vehicle such as the interior trim 110 thereof via the connector 230. In one example and as illustratively depicted in FIG. 3A through FIG. 3C, the interior trim 110 may be formed with an opening 350, and the housing 210 may at least be partially received within the opening 350.

In the embodiments depicted herein in the FIGs, the insert 220 is connected to the connector 230, and rotates about the connector 230. The connector 230 may include a pair of connector ends 232, 234. The housing 210 or the interior trim 110 may include a pair of cavities 252, 254 to at least partially receive the connector ends 232, 234, respectively. Thus, the connector ends 232, 234 may rotate within the cavities 252, 254, thereby rotatably connecting the insert 220 to the housing 210 or the interior trim 110. In particular, the insert 220 may include a pair of opposing side walls 240, 242. The connector ends 232, 234 may respectively be positioned at the side walls 240, 242 to connect the two opposing side walls 240, 242 of the insert 220 to the housing 210 or the interior trim 110.

Whether being connected to the interior trim 110 directly or indirectly via the housing 210, the insert 220 may be configured as detachable from the connection such that the insert 220 may come in a set with variable shapes, material and dimensions such that additional level of versatility may be provided.

Referring to FIG. 5, in one or more embodiments, the connector end 232 may include a first protrusion 510 and a second protrusion 520. The cavity 252 may include a first recess 530 and a second recess 540 spaced apart with an angle positioned there-between and to correspond respectively to the first and second protrusions 510, 520 in position. Thus, when the connector end 232 rotates within the cavity 252, the first protrusion 510 may be received within the first recess 530 and the second protrusion 520 may be received within the second recess 540, and accordingly positioning of the connector end 232 relative to the cavity 252 may be achieved at this or other suitable locations described herein elsewhere.

Further, the first protrusion 510 may include a polymeric material. Accordingly, and when the first protrusion 510 is received within the first recess 530, the connector end 232 is not to rotate freely relative to the first cavity 252, and therefore the insert 220 is to be secured at a certain position. When the user desires to rotate the insert 220 to another position, a given force may be applied. With the elasticity of the polymeric material, the first protrusion 510 may deform under the given force and move away from the first recess 530. Thus, the connector end 232 may rotate relative to the first cavity 252, for instance, along direction B. When the first protrusion 510 moves to the second recess 540, the first protrusion 510 may return to its initial shape due to the elasticity of the polymeric material and be received within the second recess 540, so that the connector end 232 may not further rotate relative to the cavity 252, and the insert 220 may then be positioned at this new location.

It is to be appreciated that what is described herein in relation to the first protrusion 510 may similarly be applicable to the second protrusion 520. Moreover, the connector end 232 may include more or fewer protrusions as needed, so as to provide additional level of resistance to rotation and hence stability of support.

In one or more embodiments, the connector end 230 such as any one of the connector ends 232, 234 may include an outer shell 560 and an inner core 550 positioned between the outer shell 560 and the interior trim 110 at an assembly position such as the position illustratively depicted in FIG. 2. The inner core 550 and the outer shell 560 may be of different materials. In one embodiment, the inner core 550 may include a metal material so as to provide structural strength to better support the insert 220, and the outer shell 560 may include a flexible material such as a polymeric material or rubber so as to effectuate fixable rotation of the connector end relative to the cavity as described herein elsewhere.

Referring back to FIG. 2, the article attachment assembly 100 may further include a shaft 236 to support the pair of connector ends 232, 234. In certain embodiments, and particularly when the connector ends 232, 234 are of a core-shell configuration illustratively depicted in FIG. 5, the shaft 236 may connect and support the inner core 550 and optionally form an integral and one-piece structure along with the inner core 550. Accordingly, the shaft 236 and the inner core 550 may include and/or be formed of a strength-imparting material such as metals and metal alloys, while the outer shell 560 may include and/or be formed of a flexibility-imparting material such as a carbon and/or silicon containing polymer such that the outer shell 560 may be assembled onto the inner core 550 when suitable.

Referring back to FIG. 3A to 3C, various cross-sectional views of the article attachment assembly 100 according to one or more embodiments of the present invention are illustratively depicted, with the insert 220 being at various rotational position. It is to be appreciated that the insert 220 is illustratively depicted as a triangle with three walls 312, 314, and 316 in the FIGs as shown. The insert 220 may include more or fewer walls in other embodiments, the positioning of which may be supported via more or fewer protrusions-and-recess sets such as the sets of the protrusions 510, 520 and the recesses 530, 540 illustratively depicted in FIG. 5, as mentioned herein elsewhere.

The insert 220 may at least include the first wall 312 and the second wall 314. The first and second walls 312, 314 may be connected to each other with a first angle α positioned there-between. Angle α may vary dependent upon for instance the number of walls or sides included in the insert 220. Straightforwardly, the more walls or sides the insert 220 includes or is formed of, the greater the value of the angle α. However, the value of the angle α is by definition no greater than 180 degrees. Although the angle α is illustratively depicted as being of 60 degrees, it may be of 30 degrees, 45 degrees, 75 degrees, or any other suitable value as long as the rotation of the insert 220 about the connector 230 is not negatively affected.

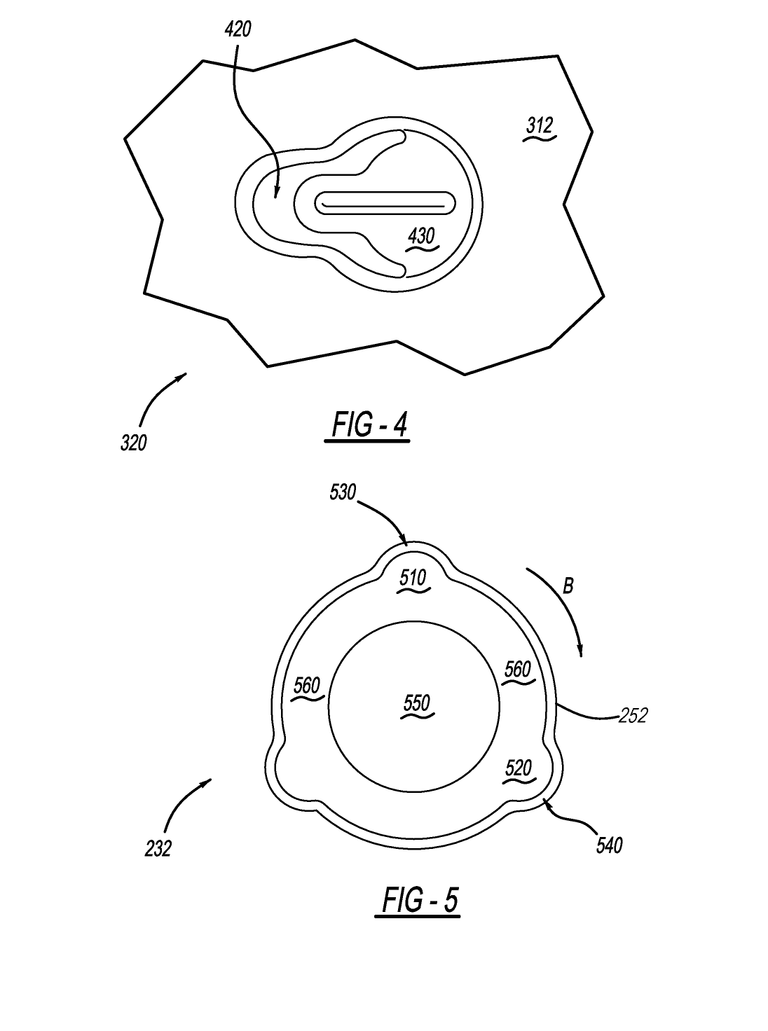

The first wall 312 may define thereupon the first attachment receptor 320. As mentioned herein elsewhere, and in one or more embodiments, the first attachment receptor 320 may be a cargo net holder. Referring to FIG. 4, there is illustratively depicted the first attachment receptor 320 as a cargo net holder or the cargo net holder 320. The cargo net holder 320 may define thereupon a keyhole slot 420.

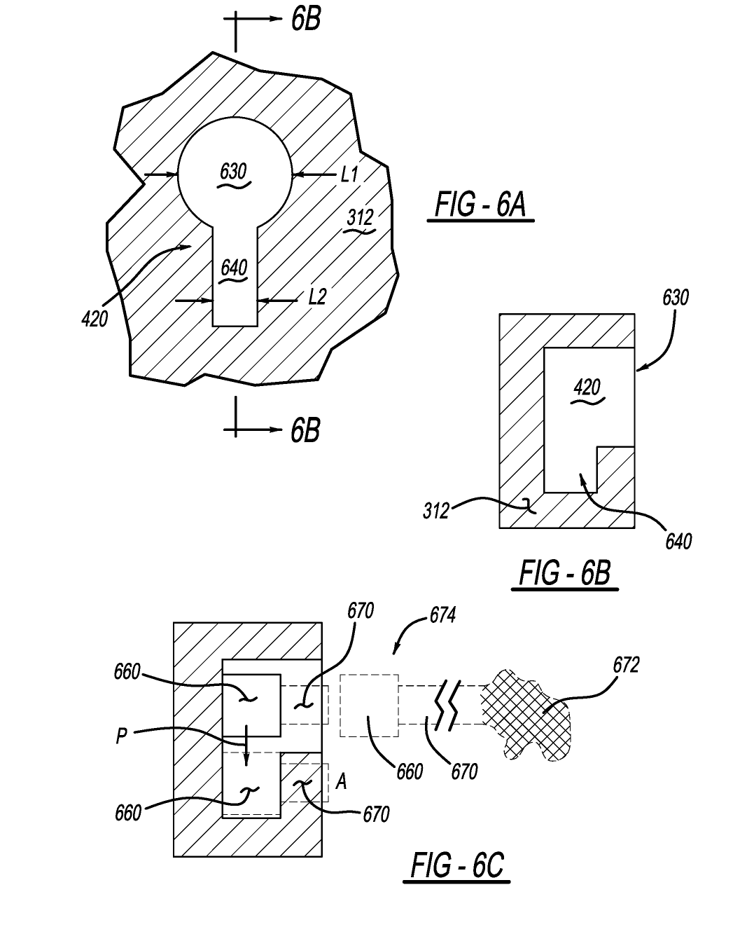

Further, referring to FIGS. 6A to 6C, the keyhole slot 420 may include a relatively larger cavity or an aperture 630 with a greater dimension L1 and a relatively smaller cavity or aperture 640 with a smaller dimension L2. For illustration purposes, the first aperture 630 is shown as a circle, and the second aperture 640 is shown as a rectangle. In another one or more embodiments, the first aperture 630 and/or the second aperture 640 may be formed in cross-sectional shape of an ellipse, a rectangle, a triangle, or any other regular or irregular shapes as desirable to accommodate different shapes of a cargo net shaft.

Referring back to FIG. 6C, a cargo net bar 674 to connect an article net 672 may include a body portion 670 and an end portion 660. The end portion 660 has a cross-sectional size larger than that of the body portion 670. In one embodiment, the cross-section of the end portion 660 may be a circle with a dimension greater than L2 and smaller than L1, and the cross-section of the body portion 670 may be a circle with a dimension smaller than L2. Accordingly, and as illustratively depicted in FIG. 6C, the insert 220 is rotated such that the cargo net holder 320 is positioned as shown in FIG. 3B, the end portion 660 of the cargo net bar may be inserted into the first aperture 630, and then be moved into a holding position A along arrow P. Thus, the body portion 670 may extend through the second aperture 640. The end portion 660, however, is of a dimension greater than L2 and will not pull through the second aperture 640. In this way the cargo net bar 674 may be secured to the cargo net holder 320 and to the vehicle interior trim 110.

Furthermore, and referring back to FIG. 4, the cargo net holder 320 may be configured with a cover 430 which may be received within the keyhole slot 420. Thus, when the cargo net holder 320 or the first wall 312 is at a use position, the cover 430 may be utilized to cover the keyhole slot 420 to reduce entry of dust or foreign body into the keyhole slot 420. The cover 430 may be formed by any suitable materials, such as one or more of metal, rubber and plastic.

Referring back to FIG. 3C, the second attachment receptor 330 different from the first attachment receptor 320 may be defined on the second wall 314. Such structure is particularly advantageous in that different attachment receptors may be defined on walls connected to each other with an angle positioned there-between, thereby accommodating different positional or strength requirements for different attachment receptors. As mentioned herein elsewhere, the second attachment receptor 330 may be an electronic device holder, such as a cellphone holder, an iPad holder, an e-book reader holder, and a GPS (Global Positioning System) holder. It is to be appreciated that in other embodiments, the first attachment receptor 320 may be an electronic device holder, and the second attachment receptor 330 may be a cargo net holder. In another one or more embodiments, the first and/or second attachment receptors 320, 330 may include other types of connecting devices, such as coat hooks and slidable slots. In the embodiments illustratively depicted in the FIGs herein, the first and second attachment receptors 320, 330 are shown as being formed integrally with the insert 220, thereby forming an integral one-piece structure, and in other embodiments, they may be formed independently and then be attached to the insert 220 or the first wall 312 and/or second wall 314.

Referring back to FIG. 3A, and in one embodiment, the insert 220 may further include a third wall 316. The third wall 316 may be connected to the first wall 312 with a second angle γ positioned there-between. Similar to the first angle α, although the second angle γ is illustratively depicted as being of 60 degrees, it may be of 30 degrees, 45 degrees, 75 degrees, or any other suitable value as long as the rotation of the insert 220 about the connector 230 is not to be negatively affected.

Similarly, the third wall 316 may be connected to the second wall 314 with a third angle β positioned there-between. Although the second angle β is illustratively depicted as being of 60 degrees, it may be of 30 degrees, 45 degrees, 75 degrees, or any other suitable value as long as the rotation of the insert 220 about the connector 230 is not to be negatively affected.

In the embodiments illustratively depicted in FIGs, the third wall 316 may be of a flat outer surface. Furthermore, the outer surface of the third wall 316 may be aligned with the surface of housing 210 or interior trim 110. Accordingly, and when being positioned as shown in FIG. 3A and FIG. 1, the third wall 316 faces the cabin interior, and the interior trim 110 may present a smooth surface such that the article attachment assembly 100 is not very noticeable for an enhanced aesthetical feel. In another one or more embodiments, and similar to the first wall 312 and the second wall 314, the third wall 316 may define a third attachment receptor (not shown) same to or different than the first attachment receptor 320 or the second attachment receptor 330, thereby providing more options for the user.

The walls 312, 314 and 316 may be of any suitable material for their intended operational purpose of bearing weight and pulling force associated with the weight. Non-limiting examples of the suitable material include metals, metal alloys, and polymers such as carbon and/or silicon containing polymers. In certain embodiments, the walls 312, 314 and 316 are formed as an integral and one-piece structure which may be formed via molding to deliver additional level of structural integrity and stability of support.

When employed, the housing 210 may differ in material from the interior trim 110 to provide for instance enhanced aesthetic feel. Non-limiting examples of the material of the housing 210 include metals, metal alloys, and polymers such as carbon and/or silicon containing polymers.

In one or more embodiments, the present invention provides an article attachment assembly. One skilled in the art will readily recognize from such discussion, and from the accompanying drawings and claims that various changes, modifications and variations can be made therein without departing from the true spirit and fair scope of the invention as defined by the following claims.

What is claimed is:

1. An article attachment assembly, comprising:
a connector; and
an insert to be connected to and rotate about the connector, the insert including a first wall and a second wall connected together with an angle positioned there-between, the first wall defining thereupon a first attachment receptor, and the second wall defining thereupon a second attachment receptor different from the first attachment receptor.

2. The article attachment assembly of claim 1, wherein one of the first attachment receptor and the second attachment receptor is a cargo net holder.

3. The article attachment assembly of claim 1, wherein one of the first attachment receptor and the second attachment receptor is an electronic device holder.

4. The article attachment assembly of claim 1, further comprising a third wall connected to the first wall and the second wall.

5. The article attachment assembly of claim 1, wherein the connector includes a pair of connector ends to respectively connect two opposing sides of the insert to a housing.

6. The article attachment assembly of claim 5, wherein the connector further includes a shaft to connect the pair of connector ends.

7. The article attachment assembly of claim 5, wherein at least one of the pair of connector ends of the connector includes a first protrusion and a second protrusion spaced apart from said first protrusion.

8. The article attachment assembly of claim 7, wherein at least one of the first protrusion and the second protrusion includes a polymeric material.

9. The article attachment assembly of claim 5, wherein at least one of the pair of connector ends includes an outer shell with a shell material and an inner core with a core material different from the shell material.

10. The article attachment assembly of claim 1, wherein the insert is of an integral one-piece structure.

11. An article attachment assembly of a vehicle, comprising:
a housing to be connected to an interior trim of the vehicle;
a connector; and
an insert to be rotatably connected to the housing via the connector, the insert including a first wall and a second wall connected together with a first angle positioned there-between, the first wall defining thereupon a first attachment receptor, and the second wall defining thereupon a second attachment receptor different from the first attachment receptor, and the insert further including a third wall connected to the first wall and the second wall with a second angle and a third angle positioned respectively relative thereto.

12. The article attachment assembly of claim 11, wherein the connector includes a pair of connector ends to respectively connect two opposing sides of the insert to the housing, wherein the connector further includes a shaft to connect the pair of connector ends, and wherein at least one of the connector ends of the connector includes a first protrusion and a second protrusion spaced apart to engage a first recess and a second recess defined on the housing to stabilize positioning of the first wall, the second wall, and the third wall.

13. The article attachment assembly of claim 12, wherein at least one of the pair of connector ends includes an outer shell with a shell material and an inner core with a core material different from the shell material.

14. An article attachment assembly of a vehicle, comprising:
a housing to be connected to an interior trim of the vehicle; and
an insert including two opposing side walls rotatably connected to the housing via a connector and a first wall and a second wall positioned between the two opposing side walls,
wherein the first wall includes a cargo net holder defining thereupon a keyhole slot.
